(19) United States
(12) Patent Application Publication
(10) Pub. No.: US 2005/0099592 A1
(43) Pub. Date: May 12, 2005

(54) Assembly of prescription lens unit and sports-sunglasses

(76) Inventors: Suk-Jae Lee, Daegu (KR); Ju-Jae Lee, Daegu (KR); Hyun-Jun Lee, Daegu (KR); Sung-Jun Lee, Daegu (KR)

Correspondence Address: PIPER RUDNICK LLP, P. O. BOX 9271, RESTON, VA, 20195, US

(21) Appl. No.: 10/982,765

(22) Filed: Nov. 8, 2004

(30) Foreign Application Priority Data
Nov. 8, 2003 (KR) 2003-35019

(51) Int. Cl. G02C 5/02

(52) U.S. Cl. 351/134

(57) ABSTRACT

Disclosed herein is an assembly of a prescription lens unit and sports-sunglasses. The sports-sunglasses takes the form of goggle type sports-sunglasses including a tinted lens and a sunglass rim, but not limited thereto. The sports-sunglasses is provided with an insert unit, which is fixed to a lower end of the tinted lens and mounted with one or more magnets. The prescription lens unit has a bridge, which is mounted with one or more magnets corresponding to the magnets of the insert unit. With such a configuration, the prescription lens unit is detachably coupled to the sports-sunglasses.

### BACKGROUND OF THE INVENTION

1. Field of the Invention

The present invention relates to an assembly of a prescription lens unit and sports-sunglasses, and more particularly to an assembly wherein a prescription lens unit is detachably coupled to sports-sunglasses, for example, goggle type sports-sunglasses used in a variety of sports.

2. Description of the Related Art

Recently, a variety of sports, such as skiing, are generally performed in the daytime, and hence various kinds of sports-sunglasses, made of various materials and designs, are increasingly introduced and used to protect wearer's eyes.

However, conventional sports-sunglasses are generally formed as ordinary sunglasses with tinted lenses, which are for persons not wearing prescription lenses. Therefore, persons who requires prescription lenses have to order special sunglasses mounted with the prescription lenses conforming to their defective eyesight, or to separately wear soft or hard lenses. Such an inconvenience in use of the conventional sports-sunglasses is worsen when the sports-sunglasses are used in special sports requiring visual acuity.

The above described problem is especially serious in the case of goggle type sports-sunglasses having a monolithic structure suitable to resist any external impact.

### SUMMARY OF THE INVENTION

Therefore, the present invention has been made in view of the above problems, and it is an object of the present invention to provide an assembly of a prescription lens unit and sports-sunglasses, such as goggle type sports-sunglasses for use in a variety of sports.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a rear perspective view illustrating an assembly of a prescription lens unit and sports-sunglasses in accordance with a first embodiment of the present invention, in a state wherein the prescription lens unit is separated from the sports-sunglasses;

FIG. 2 is a front perspective view illustrating the prescription lens unit and an insert unit shown in FIG. 1, a circle located at a left side showing a side cross-sectional shape taken along the line A-A shown in FIG. 2;

FIG. 3 is a front perspective view illustrating a prescription lens unit and an insert unit in accordance with a second embodiment of the present invention, a circle located at a left side showing a side cross-sectional shape taken along the line B-B shown in FIG. 2; and

FIG. 4 is a front perspective view illustrating a prescription lens unit and an insert unit in accordance with a third embodiment of the present invention, a circle located at a left side showing a side cross-sectional shape taken along the line B-B shown in FIG. 4.

### DESCRIPTION OF THE PREFERRED EMBODIMENTS

Now, preferred embodiments of the present invention will be described in detail with reference to the annexed drawings.

As can be seen from the annexed drawings and following description, sports-sunglasses, included in an assembly of the present invention, are goggle type sports-sunglasses. However, it should be understood that other various kinds of sports-sunglasses having various shapes and made of various materials, can be utilized as the same concept as the goggle type sports-sunglasses.

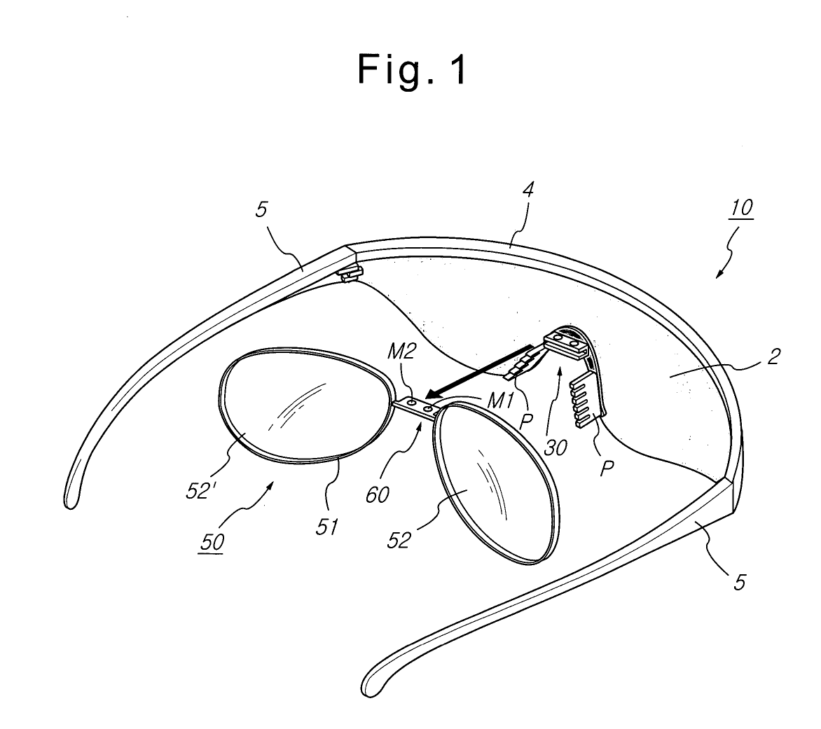

FIG. 1 is a rear perspective view illustrating an assembly of a prescription lens unit and sports-sunglasses in accordance with a first embodiment of the present invention. As shown in FIG. 1, the assembly of the present invention comprises: goggle type sports-sunglasses 10, and a prescription lens unit 50 for persons having defective eyesight.

The sports-sunglasses 10, having a conventional design shown in FIG. 1, includes a tinted lens 2 taking a monolithic plate structure. Such a lens 2 is formed by molding a tinted plastic material. In the present invention, at a lower end of the lens 2 is mounted an insert unit 30 through insertion or using an adhesive. Such an insert unit 30 has a general contour following that of the nose.

The sports-sunglasses 10 of the present invention are goggle type sports-sunglasses wherein an upper edge of the tinted lens 2 is inserted and fixed to a sunglass rim 4, and at opposite ends of the sunglass rim 4 are hingedly connected a pair of legs 5, respectively. The insert unit 30 is prefabricated separately with the tinted lens 2 by making use of a molding process, and later fixedly inserted to the tinted lens 2. Alternatively, the insert unit 30 may be integrally molded with the tinted lens 2. In both the cases, generally, to the insert unit 30 is integrally molded a pair of inclined nose contact pads (P) in order to allow the insert unit 30 to be stably and firmly seated on the nose.

Now, means for detachably coupling the prescription lens unit 50 to the sports-sunglasses 10 in use will be explained.

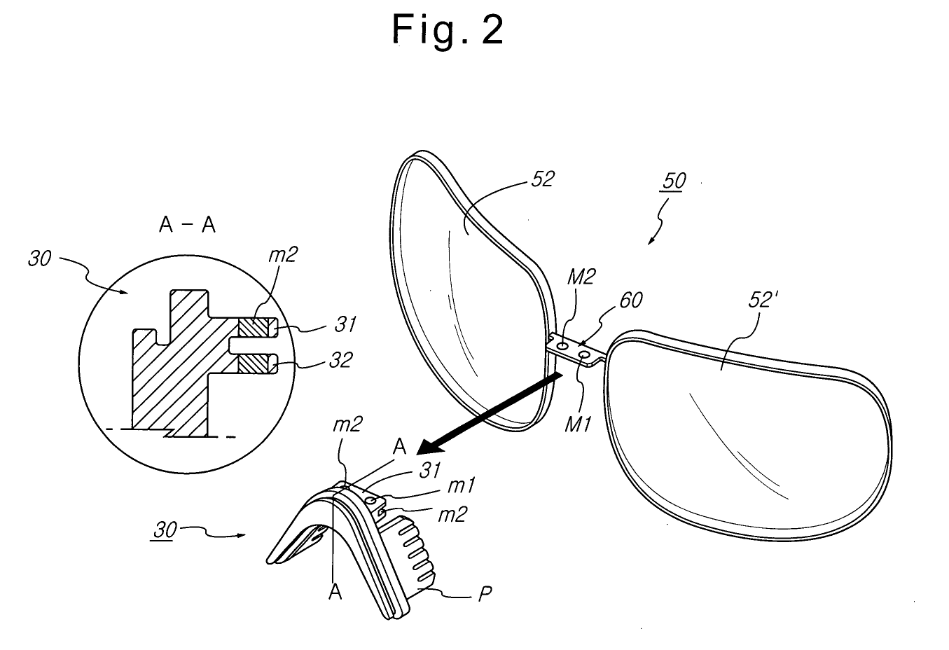

Referring to FIG. 2 illustrating a first embodiment of the present invention, the insert unit 30 includes a pair of integrally molded upper and lower insert pieces 31 and 32. The insert pieces 31 and 32 protrude inward toward a wearer, namely, the prescription lens unit 50, and together form a U-shaped cross section. In the upper and lower insert pieces 31 and 32 are inserted magnets M1 and M2. The magnets M1 and M2 may penetrate through the insert pieces 31 and 32, or be partially inserted and fixed in the insert pieces 31 and 32. Further, the magnets M1 and M2 may be provided solely or together in the every insert piece 31 or 32.

The prescription lens unit 50 having no legs according to the present embodiment includes: a pair of prescription lenses 52 and 52′, a pair of lens rims 53 and 53′ surrounding the respective lenses 52 and 52′, and a horizontal plate shaped bridge 60 connecting the lens rims 53 and 53′ to each other. In the bridge 60 are inserted one or more magnets m1 and m2.

With such a configuration, as the bridge 60 of the prescription lens unit 50 is inserted into a space defined by the insert pieces 31 and 32, having the U-shaped cross section, of the insert unit 30, the prescription lens unit 50 and the sports-sunglasses 10 can be securely coupled to each other by way of a magnetic force between the magnets M1 and M2 and m1 and m2. It will be easily understood that, as occasion demands, the sports-sunglasses 10 is solely usable by simply separating the prescription lens unit 50 therefrom.

Although the above described embodiment discloses the four corresponding magnets M1 and M2 and m1 and m2, if necessary, the respective pairs of magnets M1 and M2; m1 and m2 may take the form of a single bar.

Alternatively, one pair of the magnets M1 and M2 or m1 and m2 are maintained, whereas the other pair of the magnets m1 and m2 or M1 and M2 are substituted by special metals easily responsible to the magnets or other soft magnetic materials. Of course, even in this case it is possible to achieve the same effect as that of the above embodiment.

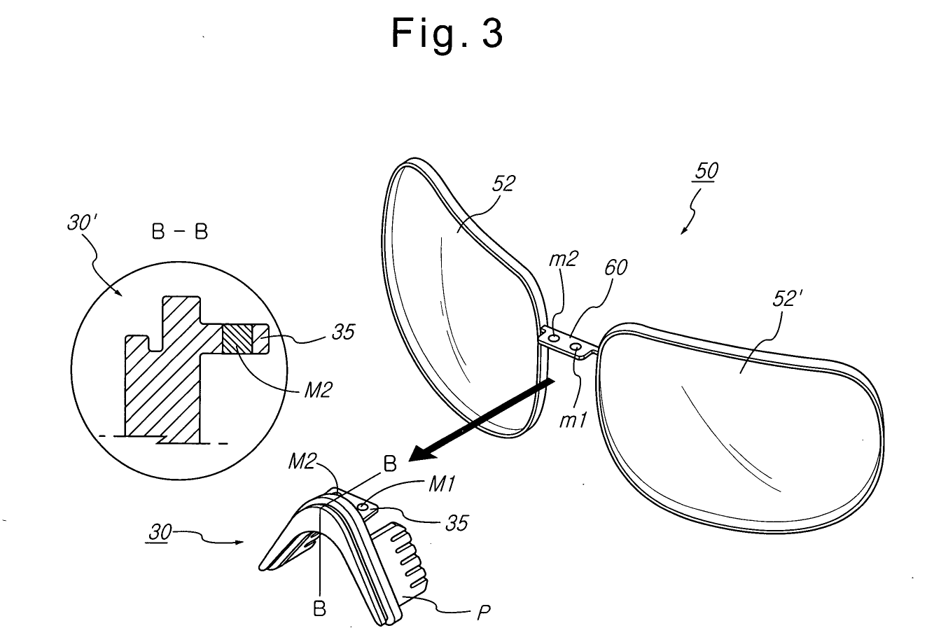

FIG. 3 illustrates a second embodiment of the present invention, which is slightly modified as compared to the first embodiment, but has the same technical idea as that of the first embodiment.

Considering the configuration of FIG. 3, the second embodiment is differ from the first embodiment in that an insert unit 30′ includes: a single holder piece 35, rather than the pair of insert pieces 31 and 32 of the insert unit 30 spaced apart from each other. The holder piece 35 is provided with the magnets M1 and M2, and correspondingly, the bridge 60 is provided with the magnets m1 and m2.

In this case, as the bridge 60 is simply seated on the holder piece 35, the prescription lens unit 50 can be more easily fastened to the insert unit 30′ as compared to an insertion manner requiring careful manipulation.

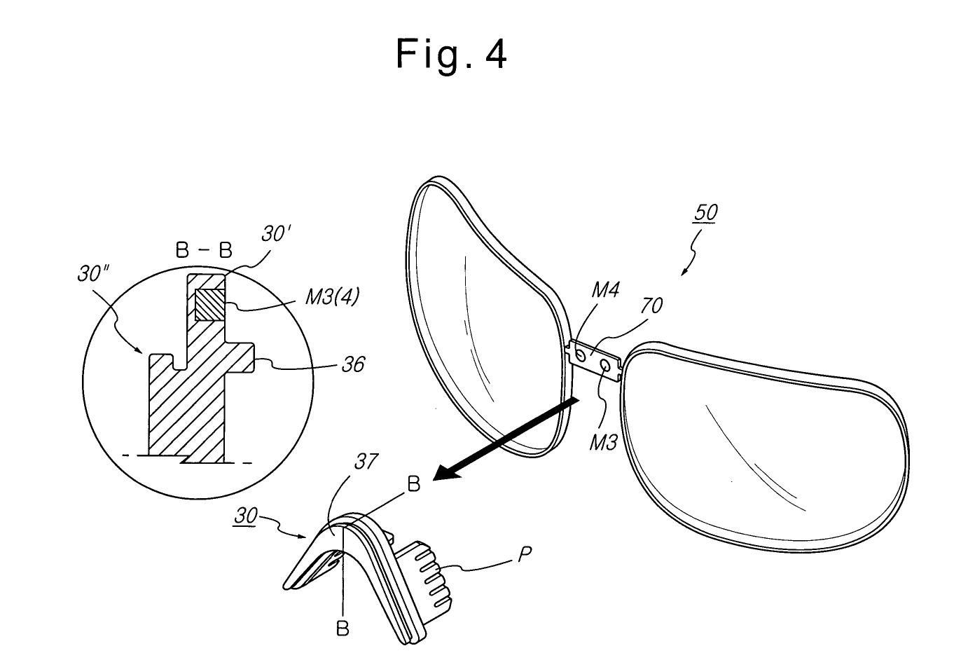

FIG. 4 illustrates a third embodiment of the present invention belonging to the technical idea of the present invention.

The present embodiment employs an insert unit 30″ including: an uppermost vertical protrusion 37, and one or more magnets M3 and M4 inserted in the protrusion 37. Corresponding to the magnets M3 and M4, the present embodiment provides the prescription lens unit 50 with a bridge 70 taking the form of a vertical metal plate.

Alternatively, the bridge 70 may be formed of a non-magnetic plate and provided with magnets m3 and m4 corresponding to the magnets M3 and M4 of the insert unit 30″. It is noted that the magnets m3 and 4 exhibit the same attachment efficiency as the metal plate.

In the latter case, in order to prevent the bridge 70 from falling upon receiving an external force in a state wherein the magnets M3 and M4 are attached to the magnets m3 and m4, the insert unit 30″ preferably further includes a support piece 36 below the magnets M3 and M4. The support piece 36 is integrally molded to the insert unit 30 so as to protrude inward toward the wearer, namely, the prescription lens unit 50.

As apparent from the above description, the present invention provides an assembly of a prescription lens unit and sports-sunglasses wherein the prescription lens unit is detachably coupled inward to the sports-sunglasses, enabling a person having defective eyesight to conveniently wear the sports-sunglasses without an interference of sunlight. It is noted that the sports-sunglasses are freely selectable in various kinds of sports-sunglasses made of various materials and having various designs.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An assembly of a prescription lens unit and sports-sunglasses, wherein:
the sports-sunglasses taking the form of goggle type sports-sunglasses including a tinted lens and a sunglass rim, but not limited thereto, the sports-sunglasses having an insert unit fixed to a lower end of the tinted lens and mounted with one or more magnets; and
the prescription lens unit having a bridge mounted with one or more magnets corresponding to the magnets of the insert unit,
whereby the prescription lens unit is detachably coupled to the sports-sunglasses.

2. The assembly as set forth in claim 1, wherein:
the insert unit includes a pair of insert pieces in which the magnets are mounted, respectively, the insert pieces protruding inward toward a wearer and defining together a U-shaped cross section; and
the bridge of the prescription lens unit, having the magnets, takes the form of a horizontal plate suitable to be inserted into a space defined between the insert pieces of the insert unit,
whereby the magnets of the bridge are correspondingly attached to the magnets of the insert pieces.

3. The assembly as set forth in claim 1, wherein:
the insert unit includes a single holder piece in which the magnets are mounted, the single holder piece protruding inward toward the prescription lens unit; and
the bridge of the prescription lens unit, having the magnets, takes the form of a horizontal plate suitable to be seated on the holder piece of the insert unit,
whereby the magnets of the bridge are correspondingly attached to the magnets of the holder piece.

4. The assembly as set forth in claim 1, wherein:
the insert unit includes an uppermost vertical protrusion in which the magnets are vertically mounted, the protrusion integrally extending upward from an upper end of the insert unit; and
the bridge of the prescription lens unit, having the magnets, takes the form of a vertical plate suitable to come into close contact with the protrusion of the insert unit,
whereby the magnets of the bridge are correspondingly attached to the magnets of the protrusion.

5. The assembly as set forth in claim 1, wherein the magnets of the insert unit or bridge take the form of a single bar.

6. The assembly as set forth in claim 1, wherein the magnets mounted in one of the insert unit and the bridge are maintained, and the magnets mounted in the other one of the insert unit and the bridge are substituted by special metals easily responsible to the magnets or other soft magnetic materials.
